(19) United States
(12) Patent Application Publication
(10) Pub. No.: US 2024/0078809 A1
(43) Pub. Date: Mar. 7, 2024

(54) Contextual Image Recognition Producing Notifications based on Knowledge Corpus Information

(71) Applicant: International Business Machines Corporation, Armonk, NY (US)

(72) Inventors: Martin G. Keen, Cary, NC (US); Jeremy R. Fox, Georgetown, TX (US); Alexander Reznicek, Troy, NY (US); Bahman Hekmatshoartabari, White Plains, NY (US)

(21) Appl. No.: 17/929,897

(22) Filed: Sep. 6, 2022

(51) Int. Cl. G06V 20/50; G06Q 10/10; G06V 10/70; G06V 10/764; H04L 51/224

(52) U.S. Cl. CPC G06V 20/50; G06Q 10/1093; G06V 10/764; G06V 10/768; H04L 51/224

(57) ABSTRACT

Determining contextual relevance of images to automatically generate notifications is provided. An analysis of an image is performed using a set of machine learning models. A context of a current environment of a user captured in the image is determined based on the analysis of the image. A comparison of the context of the current environment of the user is performed against the known information stored in the knowledge corpus. An insight corresponding to the user activity is generated based on the comparison of the context of the current environment of the user against the known information stored in the knowledge corpus. The insight identifies a set of interested parties corresponding to the user who are to be notified and provides proactive assistance to the user to automatically generate a notification in real time. The notification is generated containing the insight corresponding to the user activity.

### BACKGROUND

### 1. Field

The disclosure relates generally to image processing and more specifically to determining contextual relevance of images to automatically generate notifications containing insights corresponding to the images.

### 2. Description of the Related Art

An image may be, for example, a photograph, a frame of a video, or the like. An image is represented by its dimensions (e.g., height and width) based on the number of pixels. A pixel is a point on the image that takes on a specific location, shade, opacity, color, and the like.

Image processing utilizes a computer to perform a sequence of operations at each pixel of the image. Image processing transforms the image into digital form and performs the sequence of operations to obtain some information from the image. The output of image processing may be, for example, an enhanced image or characteristics associated with that image.

### SUMMARY

According to one illustrative embodiment, a computer-implemented method for determining contextual relevance of images to automatically generate notifications is provided. A computer performs an analysis of an image using a set of machine learning models. The computer determines a context of a current environment of a user captured in the image based on the analysis of the image. The context of the current environment of the user captured in the image includes at least one of a set of identified objects captured in the image, geographic location where the image was captured, date and time the image was captured, correlation to a user activity listed in an entry of an electronic calendar corresponding to the user on the date the image was captured, and correlation to known information contained in a set of previous messages corresponding to the user stored in a knowledge corpus. The computer performs a comparison of the context of the current environment of the user against the known information stored in the knowledge corpus. The computer generates an insight corresponding to the user activity based on the comparison of the context of the current environment of the user against the known information stored in the knowledge corpus, wherein the insight identifies a set of interested parties corresponding to the user who are to be notified and provides proactive assistance to the user to automatically generate a notification in real time. The computer generates the notification containing the insight corresponding to the user activity. According to other illustrative embodiments, a computer system and computer program product for determining contextual relevance of images to automatically generate notifications are provided.

### BRIEF DESCRIPTION OF THE DRAWINGS

FIG. 1 is a pictorial representation of a computing environment in which illustrative embodiments may be implemented;

FIG. 2 is a diagram illustrating an example of an image contextual relevancy determination process in accordance with an illustrative embodiment;

FIG. 3 is a diagram illustrating an example of an image in accordance with an illustrative embodiment;

FIG. 4 is a diagram illustrating an example of a notification in accordance with an illustrative embodiment;

FIG. 5 is a flowchart illustrating a process for automatically generating notifications containing insights in accordance with an illustrative embodiment; and

FIGS. 6A-6B are a flowchart illustrating a process for determining contextual relevance of images in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

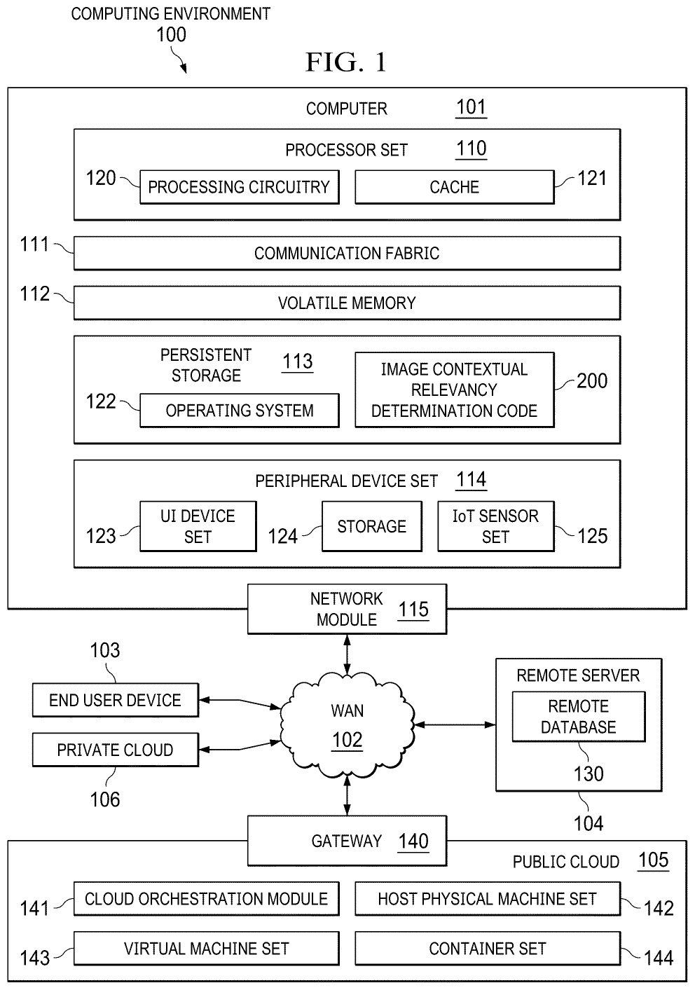

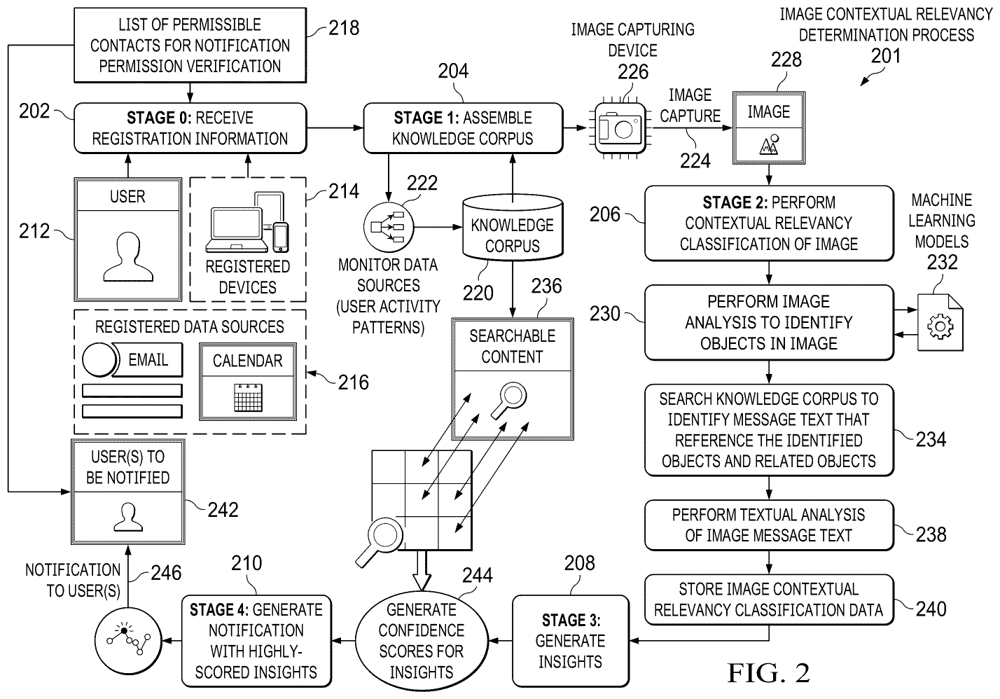

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as image contextual relevancy determination code 200. Image contextual relevancy determination code 200 determines contextual relevance of images to automatically generate notifications containing insights corresponding to the images based on known information stored in a knowledge corpus. In addition to image contextual relevancy determination code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and image contextual relevancy determination code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in image contextual relevancy determination code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The image contextual relevancy determination code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Users typically capture images of their surrounding environments using image capturing devices, such as, for example, cameras, mobile phones, smart watches, handheld tablet computers, laptop computers, and the like. These captured images contain both structured and unstructured data. For example, object recognition in captured images can establish image aspects such as the environment where the image was captured, current activity of the user, whether people are captured in the image, inferred relationship between the people captured in the image, and the like. Further, these images can contain metadata that indicates, for example, geographic location where the image was captured, direction of image capture, date and time of image capture, and the like. However, current image processing solutions lack an ability to automatically derive contextual relevance from captured images with a high degree of accuracy or enable generation of inferences and insights from the captured images without human input. This inability leads to missed opportunities for improved situational awareness of specific user activities and their impact on others. Thus, a novel image processing solution is needed to correlate information captured within an image with contextual understanding based upon known information contained in a knowledge corpus to generate notifications to a set of individuals related to the user in some manner.

Illustrative embodiments automatically generate notifications based upon contextual identification of objects captured within an image. Illustrative embodiments correlate the identified objects within the image to a derived image context through insights generated based on known information contained in a knowledge corpus. An issue with current solutions is an inability to abstract contextual information from an image to derive meaning (e.g., automatically generate insights corresponding to the captured image based upon identified objects in the image, known information contained in a knowledge corpus corresponding to the user, and time and location of the captured image).

Illustrative embodiments are capable of determining contextual relevance of a user's environment and the user's current activity being performed in that environment from the captured image. In addition, illustrative embodiments are capable of performing an impact analysis on the determined contextual relevance to predict an outcome of the user's current activity, such as, for example, the user will be late for the user's next scheduled meeting due to the user's current activity.

Illustrative embodiments analyze the image, along with any message (e.g., caption) and metadata included with the image, to determine the contextual relevance of the environment corresponding to the user captured in the image and correlate the determined contextual relevance to the current activity of the user based upon known activity patterns of the user stored in a knowledge corpus corresponding to the user. Illustrative embodiments perform the impact analysis on the determined contextual relevance to generate a set of insights corresponding to the user and send notifications to interested parties corresponding to the user based upon those insights having a confidence score greater than a defined minimum confidence score threshold value (e.g., 0.70). However, the confidence score threshold value of 0.70 is intended as an example only and not as a limitation on illustrative embodiments. In other words, illustrative embodiments may utilize any minimum confidence score threshold value, such as, for example, 0.55, 0.60, 0.65, 0.75, 0.80 or the like.

Thus, illustrative embodiments provide one or more technical solutions that overcome a technical problem with the inability of current image processing solutions to automatically derive contextual relevance from captured images and generate insights without human input. As a result, these one or more technical solutions provide a technical effect and practical application in the field of image processing.

With reference now to FIG. 2, a diagram illustrating an example of an image contextual relevancy determination process is depicted in accordance with an illustrative embodiment. Image contextual relevancy determination process 201 may be implemented in a computer, such as, for example, computer 101 in FIG. 1. For example, image contextual relevancy determination process 201 may be implemented in image contextual relevancy determination code 200 in FIG. 1.

Image contextual relevancy determination process 201 utilizes hardware and software components to determine contextual relevance of images to automatically generate notifications containing a set of insights. In this example, image contextual relevancy determination process 201 includes Stage 0 202, Stage 1 204, Stage 2 206, Stage 3 208, and Stage 4 210. However, it should be noted that image contextual relevancy determination process 201 is intended as an example only and not as a limitation on illustrative embodiments. In other words, image contextual relevancy determination process 201 can include more or fewer stages than shown. For example, one or more stages may be split into two or more stages, two or more stages may be combined into one stage, one or more stages may be removed, one or more stages may be added, or the like.

At Stage 0 202, the computer performing image contextual relevancy determination process 201 of illustrative embodiments receives registration information from user 212. During the registration process, user 212 consents to participating in the service provided by the computer performing image contextual relevancy determination process 201 of illustrative embodiments, which includes the computer analyzing captured images, user geographic location information, and a user-restricted set of information, such as, for example, user identifier, names and types of imaging devices, and other user-specified data stored locally on the imaging devices. In addition, the computer receives a list of registered image capturing devices 214 (e.g., mobile phone, tablet computer, laptop computer, desktop computer, smart watch, and the like) corresponding to user 212. The computer also receives a list of registered data sources 216 (e.g., electronic calendars, email messages, text messages, instant messages, and the like) corresponding to user 212. The duration for which user 212 grants authorization to access registered data sources 216 is configurable by user 212 according to the user's needs. Further, the computer receives a list of permissible contacts 218. Permissible contacts 218 include a set of people who are authorized by user 212 to receive notifications corresponding to user 212 from the computer. The computer utilizes the list of permissible contacts 218 to verify permission of user 212 to send the notifications. Permissible contacts 218 can include, for example, team members, co-workers, family members, friends, and the like.

At Stage 1 204, the computer performing the service of illustrative embodiments assembles knowledge corpus 220 corresponding to user 212 by initially collecting data from registered data sources 216. Further, at 222, the computer monitors registered data sources 216 on a continuous basis, a time interval basis, or on demand, for new and updated electronic calendar entries, contact list entries, email messages, text messages, instant messages, image captions or messages, and the like to determine, for example: times when user activities start and end (e.g., scheduled meeting with start time and end time); specific locations of user activities (e.g., a particular conference room for the scheduled meeting within a building); invited participants to user activities (e.g., co-workers invited to the scheduled meeting listed in an electronic calendar entry and their respective roles); and the like. The computer utilizes the data collected from registered data sources 216 (e.g., content of calendared user activities, content of email messages, content of text messages, content of contact lists, and the like) to identify and record user activity patterns corresponding to user 212, relationships between people invited to activities corresponding to user 212, geographic locations of the activities corresponding to user 212, and the like. For example, the computer can determine that Wednesday morning is a time when co-inventors of user 212 regularly hold a “Patent Buddies Meeting” at 10:00 AM according to electronic calendar entries, emails, texts, and the like of user 212. The computer can also utilize collected data to identify and record team dynamics within an organization, such as, for example, the co-inventors of user 212 comprise the “C5 Technical Team.”

At 224, user 212 utilizes image capturing device 226 to capture image 228. Image 228 may be, for example, a photograph of any environment. Alternatively, image 228 may represent a previously captured image selected by user 212 from image storage on image capturing device 226. User 212 sends image 228 to the computer performing the service of illustrative embodiments. Also, user 212 can optionally send a message in natural language with image 228 to the computer.

At Stage 2 206, the computer performing the service of illustrative embodiments receives image 228, along with any metadata regarding image 228 (e.g., timestamp, geolocation, and the like) and any accompanying message or caption, and performs contextual relevancy classification of image 228. At 230, the computer performs image analysis on image 228 to identify any objects captured in image 228 using machine learning models 232. Machine learning models 232 represent a plurality of machine learning models, such as, for example, convolutional neural networks, recurrent neural networks, transformers, and the like. The computer performs a series of image analysis steps on image 228 to determine whether any objects that can be identified exist in image 228 and what those objects are.

During the object identification process, the computer of illustrative embodiments utilizes a set of convolutional neural networks to analyze image 228 in a grid pattern to derive shapes and context. A convolutional neural network works by manipulating an image in different layers of abstraction. For example, a convolutional neural network can analyze an image layer by layer to identify the presence of a human face, eyes, ears, noses, and the like to determine whether one or more people are captured in the image. Convolutional neural networks are particularly powerful for identifying objects in images because of their ability to find patterns across hundreds or thousands of abstracted layers. In addition to identifying objects in an image, a convolutional neural network can also abstract the environment captured in the image, such as, for example, “in a vehicle,” “at the office,” or the like.

The computer performing the service of illustrative embodiments also utilizes a set of transformers to analyze image 228 for basic shapes, such as, for example, lines, curves, and the like. The computer utilizes the set of transformers to identify, for example, circles, squares, edges, and the like to identify objects such as a bicycle, desk, or the like.

Furthermore, the computer performing the service of illustrative embodiments utilizes a set of recurrent neural networks to analyze a plurality of different images of the same object and builds a knowledge base of that particular object's shape, size, orientation, and the like. For example, a recurrent neural network can compare a million images of different human faces and build a knowledge base on the shape, size, and orientation of eyes. The computer can then utilize the recurrent neural network to accurately identify the presence of eyes in any new image.

At 234, after the computer identifies objects captured in image 228, the computer searches known information in searchable content 236 of knowledge corpus 220 to identify any previous message text sent with previously captured images by user 212 that reference those same identified objects captured in image 228. The computer also searches knowledge corpus 220 for related objects, such as, for example: objects that are visually similar to those same identified objects captured in image 228 that have been referenced in text of previous messages (e.g., when illustrative embodiments identify a bike pedal in an image, the computer can also search for related objects visually similar to the bike pedal in previous message text); objects that are related to each other through context or common ownership (e.g., when user 212 includes an image of a desk in an email message sent from a home office of user 212 and user 212 later sends more images from that same location of the home office, the computer is capable of identifying those images as being sent from the home office of user 212 and searching for related objects referenced in previous message text sent from the home office of user 212); objects that are related to each other through specific known knowledge (e.g., when a calendar entry of user 212 indicates a meeting at “my home office,” the computer can predict that any images captured at that location will also show objects in “my home office.”

At 238, the computer further performs textual analysis of image message text, such as any unstructured text either provided as a message sent with image 228 (e.g., “contact my patent buddies”) or text extracted from image 228. The computer utilizes a plurality of textual analysis techniques, such as, for example, natural language understanding, natural language processing, sematic analysis, and the like. Natural language understanding analyzes linguistic context of message text to determine subject matter of the text. In addition, the computer searches knowledge corpus 220 for any previous messages sent with previously captured images containing text related to the identified objects within image 228. Further, the computer utilizes natural language understanding to identify a request and/or response expressed in a previously sent message and search for similar language expressed in subsequently received messages. For example, if the user sent a previous message stating, “I need patent help,” then the computer utilizes natural language understanding to search for later received messages containing similar language, such as “Please send me a name of a patent attorney.”

The computer utilizes natural language processing to analyze linguistic context of text contained in image 228 in order to classify image 228. For example, when the computer receives an email with image 228 capturing a person facing toward image capturing device 226 and the included message states, “Back in Denver,” then the computer utilizing natural language processing on that message text determines that the person captured in image 228 is likely in Denver.

The computer utilizes semantic analysis to determine relationships between objects identified in image 228 that are referenced in text of the included message. For example, when the computer receives image 228 capturing an airplane and a human face, along with the included message “I met my friend Joe at the airport,” then the computer utilizing semantic analysis on the text determines that “my friend” corresponding to user 212 refers to “Joe”.

At 240, after completing steps 230, 234, and 238 of Stage 2 206, the computer stores all of the image contextual relevancy classification data derived above in an image classification repository for access by the computer while performing Stage 3 208. At Stage 3 208, the computer performs analysis of the image classification data corresponding to image 228, which the computer retrieved from the image classification repository, to generate a set of insights correlated to known information contained in knowledge corpus 220. For example, after the computer identifies objects in image 228, correlates the identified objects with related objects referenced in previously received image messages stored in knowledge corpus 220, and performs any needed textual analysis of image message text, the computer analyzes this information to determine contextual relevance of image 228 to generate the set of insights corresponding to user 212 and determine whether the computer needs to generate and send a notification to a set of interested parties (i.e., users to be notified 242) corresponding to user 212.

In addition, the computer correlates and clusters the objects identified in image 228 with known information contained in knowledge corpus 220. The computer utilizes the correlating and clustering process to both identify previously identified objects in previously captured images (e.g., user 212 is likely to capture images of known objects) and determine contextually relevant information that may indicate that the computer should generate and send the notification to the set of interested parties.

The computer utilizes clustering techniques, such as, for example, K-nearest neighbor algorithms and the like. The computer utilizes K-nearest neighbor for concept search. K-nearest neighbor compares the identified objects in image 228 with all known relevant information in knowledge corpus 220 and returns the top predefined number of closest matches as possible insight predictions. For example, if, at Stage 2 206, the computer classified image 228 as a video studio and discovered in knowledge corpus 220 a calendar entry corresponding to user 212 for the previous hour entitled “shoot lightboard video,” then the computer can correlate these two concepts and return the closest set of matching objects as an insight prediction. The computer can also utilize K-nearest neighbor for object identification in image 228 since labels are not known beforehand. The computer selects each respective object identified in image 228 and identifies the K-nearest neighbors based on cosine distance of their embedding vectors. These K-nearest neighbors provide insight predictions which the computer sorts according to confidence scores or likelihood ratios. Using this approach increases the probability of the computer predicting correct concepts and insights and can be useful when image context is limited or may not influence object identification.

Further, the computer utilizes area under the curve (AUC) scores to determine image classification accuracy. An AUC score is a performance metric, where AUC=1 means that all positive and negative examples were correctly classified, while AUC=0.5 indicates random prediction. The AUC score represents the area under the receiver operating characteristic (ROC) curve that the computer generates by plotting the true positive rate (TPR) against false positive rate (FPR). For example, if the computer classifies image 228 as depicting a river and knowledge corpus 220 corresponding to user 212 contains known information regarding kayaking, fishing, and camping trips on rivers, but not on other water bodies such as lakes or oceans, then receiving an image containing a river and a kayak would result in a positive prediction.

The computer selects identified objects with the K-nearest neighbors and AUC scores to generate the set of insights correlated to objects previously identified in knowledge corpus 220. The computer also correlates these insights to data from other data sources, such as, for example, emails, text messages, instant messages, electronic calendar entries, digital maps, and the like, to identify further contextual relevance for each object and cluster. For example, the computer can generate an insight predicting that a meeting is running over the meeting's scheduled end time and, therefore, user 212 may be late to a subsequent scheduled meeting.

At 244, the computer generates a confidence score for each respective insight of the set of insights. The computer calculates confidence scores by evaluating the accuracy of past insight predictions, as well as likelihood ratios that indicate how common or rare an insight is. For example, the computer evaluates the accuracy of past insight predictions by receiving and analyzing feedback from the set of interested parties corresponding to user 212 who previously received notifications. The feedback indicates whether a particular insight prediction was correct or not. The computer utilizes the feedback as new training data to increase insight prediction accuracy over time.

At Stage 4 210, after generating the set of insights through object recognition and context, the computer now generates any needed notifications with highly-scored insights (e.g., those insights having a confidence score greater than a defined minimum confidence score threshold value, such as 0.70) to provide proactive assistance for user 212. For example, when a generated insight has a confidence score greater than the defined minimum confidence score threshold value, the computer determines that the insight is particularly relevant or important and then generates a notification for delivery to the set of interested parties (i.e., users to be notified 242) corresponding to user 212. The computer determines, for example: what notification message to send in natural language (e.g., “John Doe's current video shoot is running over and he may be delayed”); which interested parties are to receive the notification based upon determined impact; delivery time of the notification (e.g., because the computer has access to electronic calendars and geographic locations of all interested parties, the computer can estimate the most appropriate times when these individuals will be available to receive the notification); whether the notification is urgent or not; which communication channel (e.g., email, text message, instant message, or the like) to utilize to send the notification; and the like. At 246, the computer sends the notification with the set of highly-scored insights to all interested parties using the most appropriate communication channel and at the most appropriate time. In addition, the computer continues to automatically learn at what time to send notifications based on when a particular interested party has taken action in response to previous notifications.

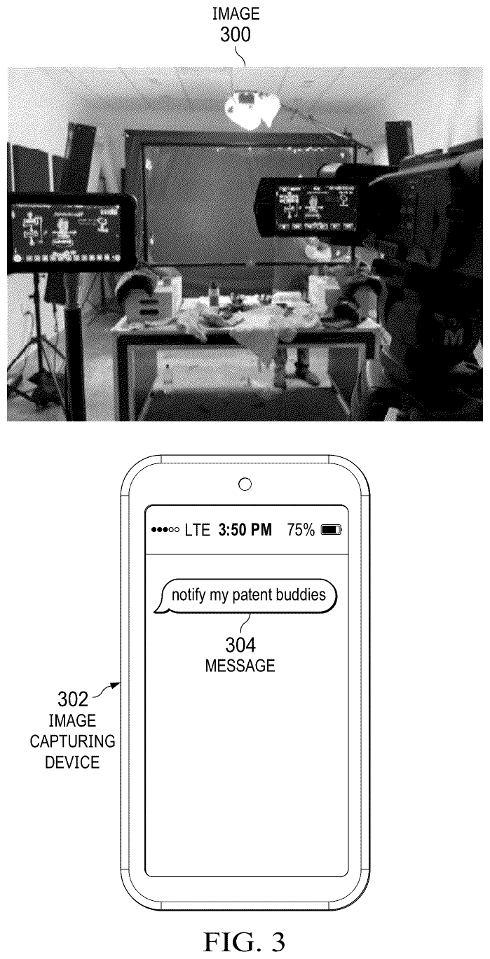

With reference now to FIG. 3, a diagram illustrating an example of an image is depicted in accordance with an illustrative embodiment. A user (e.g., a participant of an upcoming scheduled meeting) captures image 300 (e.g., a photograph, video frame, or the like) of the user's current environment utilizing image capturing device 302 and sends image 300, along with message 304 (e.g., “notify my patent buddies”), to a computer that performs the service of illustrative embodiments via a network. The user may be, for example, user 212 in FIG. 2. Image 300 may be, for example, image 228 in FIG. 2. Image capturing device 302 may be, for example, end user device 103 in FIG. 1 or image capturing device 226 in FIG. 2. The computer may be, for example, computer 101 in FIG. 1. The network may be, for example, WAN 102 in FIG. 1.

The computer performing the service of illustrative embodiments utilizes image processing, natural language processing, and knowledge corpus analysis to determine relevant context corresponding to image 300. For example, the computer identifies a time stamp of image 300 (e.g., time of image capture 10:50 AM). The computer also identifies the environment captured in image 300 (e.g., a video studio) and correlates the environment captured in image 300 to an entry in the user's electronic calendar (e.g., 9:00 AM-10:30 AM “Shoot lightboard video”) stored in a knowledge corpus corresponding to the user. The knowledge corpus may be, for example, knowledge corpus 220 in FIG. 2. In addition, the computer correlates message 304 (e.g., “notify my patent buddies”) sent with image 300 to another entry in the user's electronic calendar (e.g., 11:00 AM-12:00 PM “Discuss new idea”) to be attended by a set of interested parties (e.g., three master inventors). The set of interested parties may be, for example, users to be notified 242 in FIG. 2.

Based on the analysis of image 300 and the correlated information, the computer automatically generates an insight, which has a high degree of confidence (i.e., a confidence score greater than a defined minimum confidence score threshold value), indicating: 1) that the lightboard video shoot is running over the scheduled end time of 10:30 AM based on image 300 of the lightboard video shoot captured at 10:50 AM; 2) that the user may be late to the user's next scheduled meeting starting at 11:00 AM; and 3) that “my patent buddies” referenced in message 304, which the computer received with image 300, are the invited participants to the user's next scheduled meeting at 11:00 AM.

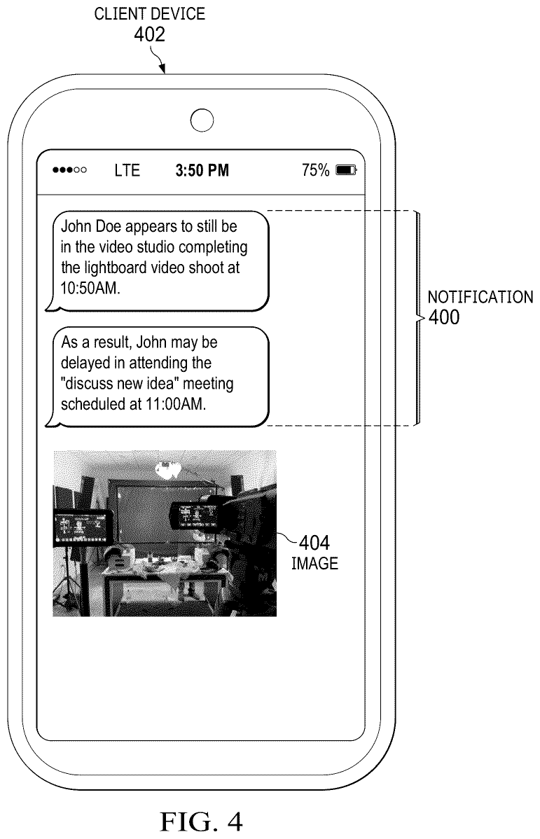

With reference now to FIG. 4, a diagram illustrating an example of a notification is depicted in accordance with an illustrative embodiment. Using the illustrative example of FIG. 3 above, the computer, such as, for example, computer 101 in FIG. 1, generates notification 400 indicating that John Doe (i.e., the user) may be late to attend the John's next scheduled meeting based on the generated insight, which has a confidence score of 0.86 indicating a high degree of confidence in the prediction. The minimum confidence score threshold level may be, for example, 0.70. Notification 400 may indicate, for example, “John Doe appears to still be in the video studio completing the lightboard video shoot at 10:50 AM. As a result, John may be delayed in attending the ‘Discuss new idea’ meeting scheduled at 11:00 AM.” The computer sends notification 400 to client device 402 of each invited participant of the upcoming “Discuss new idea” meeting via the network. Client device 402 may be, for example, end user device 103 in FIG. 1. In addition, the computer can optionally include image 404 of the user in the video studio at 10:50 AM with notification 400.

As another illustrative example, the user is in a vehicle traveling to a scheduled meeting. The user utilizes an image capturing device, such as image capturing device 226 in FIG. 2 (e.g., smart phone), to capture an image of the user in the vehicle. The user sends the captured image of the user in the vehicle to the computer performing the service of illustrative embodiments via a cellular network. The computer then extracts geolocation metadata contained in the captured image to determine a current location of the user, determines that the user's current activity is traveling in a vehicle using image analysis, and determines how long the vehicle will take to arrive at a location of the user's next meeting that is scheduled on the user's electronic calendar based upon current drive time (e.g., calculated vehicle speed and distance from the meeting location based on navigation data and/or GPS data received from the user's image capturing device (e.g., smart phone). Based on the determinations above, the computer predicts that the user will arrive five minutes late at the meeting location. As a result, the computer automatically sends a notification to the other meeting participants indicating that the user is in transit and will arrive five minutes late.

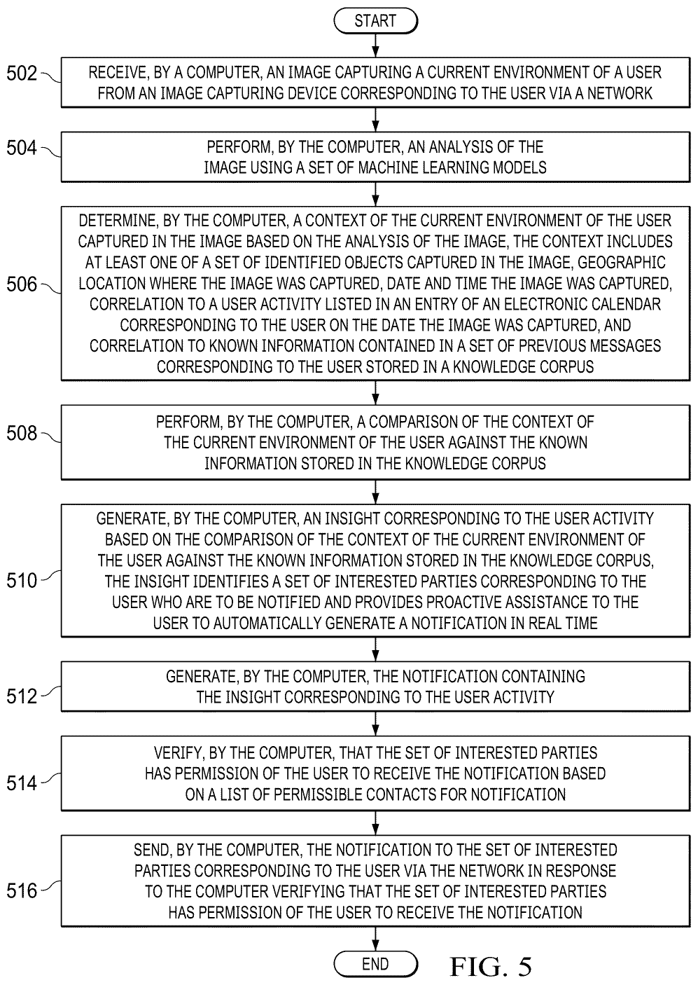

With reference now to FIG. 5, a flowchart illustrating a process for automatically generating notifications containing insights is shown in accordance with an illustrative embodiment. The process shown in FIG. 5 may be implemented in a computer, such as, for example, computer 101 in FIG. 1. For example, the process shown in FIG. 5 may be implemented in image contextual relevancy determination code 200 in FIG. 1.

The process begins when the computer receives an image capturing a current environment of a user from an image capturing device corresponding to the user via a network (step 502). In response to receiving the image, the computer performs an analysis of the image using a set of machine learning models (step 504). The computer determines a context of the current environment of the user captured in the image based on the analysis of the image (step 506). The context includes at least one of a set of identified objects captured in the image, geographic location where the image was captured, date and time the image was captured, correlation to a user activity listed in an entry of an electronic calendar corresponding to the user on the date the image was captured, and correlation to known information contained in a set of previous messages corresponding to the user stored in a knowledge corpus.

Afterward, the computer performs a comparison of the context of the current environment of the user against the known information stored in the knowledge corpus (step 508). The computer generates an insight corresponding to the image based on the comparison of the context of the current environment of the user against the known information stored in the knowledge corpus (step 510). The insight identifies a set of interested parties corresponding to the user who are to be notified and provides proactive assistance to the user to automatically generate a notification in real time.

The computer generates the notification based on the insight (step 512). The computer also verifies that the set of interested parties has permission of the user to receive the notification based on a list of permissible contacts for notification (step 514). The computer sends the notification to the set of interested parties corresponding to the user via the network in response to the computer verifying that the set of interested parties has permission of the user to receive the notification (step 516). Thereafter, the process terminates.

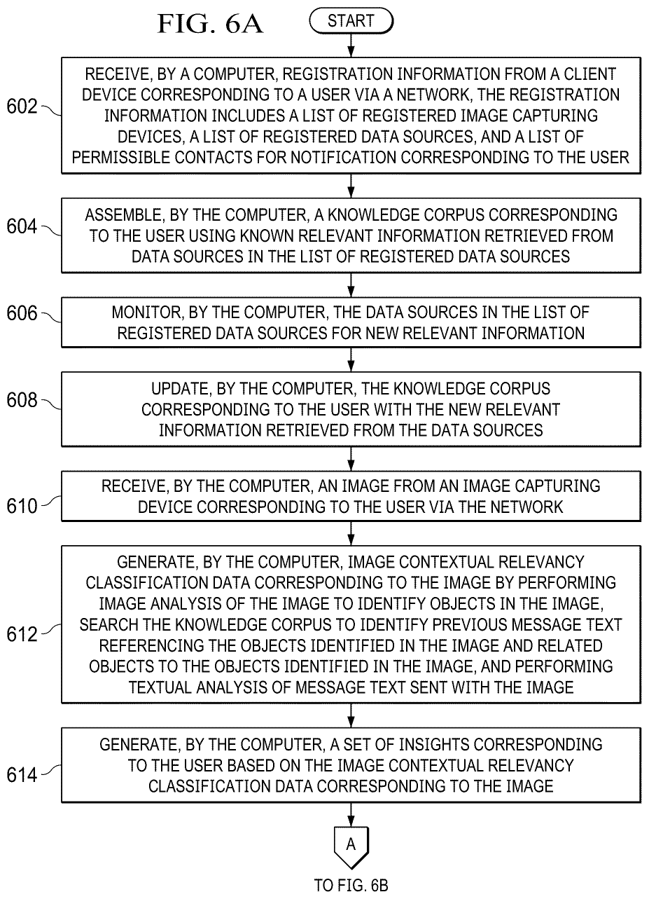

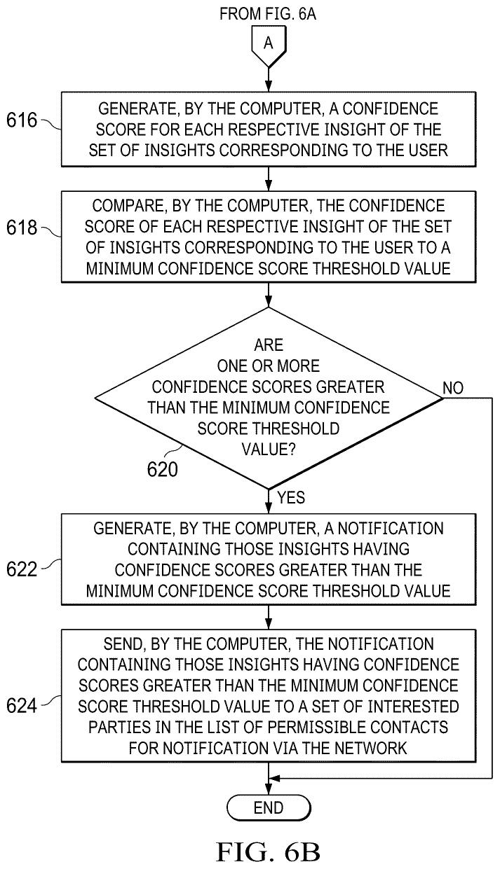

With reference now to FIGS. 6A-6B, a flowchart illustrating a process for determining contextual relevance of images is shown in accordance with an illustrative embodiment. The process shown in FIGS. 6A-6B may be implemented in a computer, such as, for example, computer 101 in FIG. 1. For example, the process shown in FIGS. 6A-6B may be implemented in image contextual relevancy determination code 200 in FIG. 1.

The process begins when the computer receives registration information from a client device corresponding to a user via a network (step 602). The registration information includes a list of registered image capturing devices, a list of registered data sources, and a list of permissible contacts for notification corresponding to the user. Afterward, the computer assembles a knowledge corpus corresponding to the user using known relevant information retrieved from data sources in the list of registered data sources (step 604). In addition, the computer monitors the data sources in the list of registered data sources for new relevant information (step 606). The computer updates the knowledge corpus corresponding to the user with the new relevant information retrieved from the data sources (step 608).

The computer receives an image from an image capturing device corresponding to the user via the network (step 610). The computer generates image contextual relevancy classification data corresponding to the image by performing image analysis of the image to identify objects in the image, searching the knowledge corpus to identify previous message text referencing the objects identified in the image and related objects to the objects identified in the image, and performing textual analysis of message text sent with the image (step 612). Then, the computer generates a set of insights corresponding to the user based on the image contextual relevancy classification data corresponding to the image (step 614). The computer also generates a confidence score for each respective insight of the set of insights corresponding to the user (step 616).

The computer compares the confidence score of each respective insight of the set of insights corresponding to the user to a minimum confidence score threshold value (step 618). The computer makes a determination as to whether one or more confidence scores are greater than the minimum confidence score threshold value (step 620). If the computer determines that no confidence scores are greater than the minimum confidence score threshold value, no output of step 620, then the process terminates thereafter. If the computer determines that one or more confidence scores are greater than the minimum confidence score threshold value, yes output of step 620, then the computer generates a notification containing those insights having confidence scores greater than the minimum confidence score threshold value (step 622). The computer sends the notification containing those insights having confidence scores greater than the minimum confidence score threshold value to a set of interested parties in the list of permissible contacts for notification via the network (step 624). Thereafter, the process terminates.

Thus, illustrative embodiments of the present invention provide a computer-implemented method, computer system, and computer program product for determining contextual relevance of images to automatically generate notifications containing insights corresponding to a user's current activity. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining contextual relevance of images to automatically generate notifications, the computer-implemented method comprising:
performing, by a computer, an analysis of an image using a set of machine learning models;
determining, by the computer, a context of a current environment of a user captured in the image based on the analysis of the image, wherein the context of the current environment of the user captured in the image includes at least one of a set of identified objects captured in the image, geographic location where the image was captured, date and time the image was captured, correlation to a user activity listed in an entry of an electronic calendar corresponding to the user on the date the image was captured, and correlation to known information contained in a set of previous messages corresponding to the user stored in a knowledge corpus;
performing, by the computer, a comparison of the context of the current environment of the user against the known information stored in the knowledge corpus;
generating, by the computer, an insight corresponding to the user activity based on the comparison of the context of the current environment of the user against the known information stored in the knowledge corpus, wherein the insight identifies a set of interested parties corresponding to the user who are to be notified and provides proactive assistance to the user to automatically generate a notification in real time; and
generating, by the computer, the notification containing the insight corresponding to the user activity.

2. The computer-implemented method of claim 1 further comprising:
verifying, by the computer, that the set of interested parties has permission of the user to receive the notification based on a list of permissible contacts for notification; and
sending, by the computer, the notification to the set of interested parties corresponding to the user via a network in response to the computer verifying that the set of interested parties has permission of the user to receive the notification.

3. The computer-implemented method of claim 1 further comprising:
receiving, by the computer, registration information from a client device corresponding to the user via a network, wherein the registration information includes a list of registered image capturing devices, a list of registered data sources, and a list of permissible contacts for notification corresponding to the user;
assembling, by the computer, the knowledge corpus corresponding to the user using known relevant information retrieved from data sources in the list of registered data sources;
monitoring, by the computer, the data sources in the list of registered data sources for new relevant information; and
updating, by the computer, the knowledge corpus corresponding to the user with the new relevant information retrieved from the data sources.

4. The computer-implemented method of claim 1 further comprising:
receiving, by the computer, the image from an image capturing device corresponding to the user via a network; and
generating, by the computer, image contextual relevancy classification data corresponding to the image by performing image analysis of the image to identify objects in the image, searching the knowledge corpus to identify previous message text referencing the objects identified in the image and related objects to the objects identified in the image, and performing textual analysis of message text sent with the image.

5. The computer-implemented method of claim 4 further comprising:
generating, by the computer, a set of insights corresponding to the user based on the image contextual relevancy classification data corresponding to the image; and
generating, by the computer, a confidence score for each respective insight of the set of insights corresponding to the user.

6. The computer-implemented method of claim 5 further comprising:
comparing, by the computer, the confidence score of each respective insight of the set of insights corresponding to the user to a minimum confidence score threshold value; and
determining, by the computer, whether one or more confidence scores are greater than the minimum confidence score threshold value.

7. The computer-implemented method of claim 6 further comprising:
responsive to the computer determining that one or more confidence scores are greater than the minimum confidence score threshold value, generating, by the computer, the notification containing those insights having confidence scores greater than the minimum confidence score threshold value; and
sending, by the computer, the notification containing those insights having confidence scores greater than the minimum confidence score threshold value to the set of interested parties in a list of permissible contacts for notification via the network.

8. The computer-implemented method of claim 1, wherein the knowledge corpus stores an electronic calendar corresponding to the user, and wherein the insight indicates that a scheduled time of the user activity corresponding to the user and the set of interested parties will be impacted based on the entry in the electronic calendar of the user.

9. A computer system for determining contextual relevance of images to automatically generate notifications, the computer system comprising:
a communication fabric;
a storage device connected to the communication fabric, wherein the storage device stores program instructions; and
a processor connected to the communication fabric, wherein the processor executes the program instructions to:
perform an analysis of an image using a set of machine learning models;
determine a context of a current environment of a user captured in the image based on the analysis of the image, wherein the context of the current environment of the user captured in the image includes at least one of a set of identified objects captured in the image, geographic location where the image was captured, date and time the image was captured, correlation to a user activity listed in an entry of an electronic calendar corresponding to the user on the date the image was captured, and correlation to known information contained in a set of previous messages corresponding to the user stored in a knowledge corpus;
perform a comparison of the context of the current environment of the user against the known information stored in the knowledge corpus;
generate an insight corresponding to the user activity based on the comparison of the context of the current environment of the user against the known information stored in the knowledge corpus, wherein the insight identifies a set of interested parties corresponding to the user who are to be notified and provides proactive assistance to the user to automatically generate a notification in real time; and
generate the notification containing the insight corresponding to the user activity.

10. The computer system of claim 9, wherein the processor further executes the program instructions to:
verify that the set of interested parties has permission of the user to receive the notification based on a list of permissible contacts for notification; and
send the notification to the set of interested parties corresponding to the user via a network in response to the computer verifying that the set of interested parties has permission of the user to receive the notification.

11. The computer system of claim 9, wherein the processor further executes the program instructions to:
receive registration information from a client device corresponding to the user via a network, wherein the registration information includes a list of registered image capturing devices, a list of registered data sources, and a list of permissible contacts for notification corresponding to the user;
assemble the knowledge corpus corresponding to the user using known relevant information retrieved from data sources in the list of registered data sources;
monitor the data sources in the list of registered data sources for new relevant information; and
update the knowledge corpus corresponding to the user with the new relevant information retrieved from the data sources.

12. The computer system of claim 9, wherein the processor further executes the program instructions to:
receive the image from an image capturing device corresponding to the user via a network; and
generate image contextual relevancy classification data corresponding to the image by performing image analysis of the image to identify objects in the image, searching the knowledge corpus to identify previous message text referencing the objects identified in the image and related objects to the objects identified in the image, and performing textual analysis of message text sent with the image.

13. The computer system of claim 12, wherein the processor further executes the program instructions to:
generate a set of insights corresponding to the user based on the image contextual relevancy classification data corresponding to the image; and
generate a confidence score for each respective insight of the set of insights corresponding to the user.

14. A computer program product for determining contextual relevance of images to automatically generate notifications, the computer program product comprising a computer-readable storage medium having program instructions embodied therewith, the program instructions executable by a computer to cause the computer to perform a method of:
performing, by the computer, an analysis of an image using a set of machine learning models;
determining, by the computer, a context of a current environment of a user captured in the image based on the analysis of the image, wherein the context of the current environment of the user captured in the image includes at least one of a set of identified objects captured in the image, geographic location where the image was captured, date and time the image was captured, correlation to a user activity listed in an entry of an electronic calendar corresponding to the user on the date the image was captured, and correlation to known information contained in a set of previous messages corresponding to the user stored in a knowledge corpus;
performing, by the computer, a comparison of the context of the current environment of the user against the known information stored in the knowledge corpus;
generating, by the computer, an insight corresponding to the user activity based on the comparison of the context of the current environment of the user against the known information stored in the knowledge corpus, wherein the insight identifies a set of interested parties corresponding to the user who are to be notified and provides proactive assistance to the user to automatically generate a notification in real time; and
generating, by the computer, the notification containing the insight corresponding to the user activity.

15. The computer program product of claim 14 further comprising:
verifying, by the computer, that the set of interested parties has permission of the user to receive the notification based on a list of permissible contacts for notification; and
sending, by the computer, the notification to the set of interested parties corresponding to the user via a network in response to the computer verifying that the set of interested parties has permission of the user to receive the notification.

16. The computer program product of claim 14 further comprising:
receiving, by the computer, registration information from a client device corresponding to the user via a network, wherein the registration information includes a list of registered image capturing devices, a list of registered data sources, and a list of permissible contacts for notification corresponding to the user;
assembling, by the computer, the knowledge corpus corresponding to the user using known relevant information retrieved from data sources in the list of registered data sources;
monitoring, by the computer, the data sources in the list of registered data sources for new relevant information; and
updating, by the computer, the knowledge corpus corresponding to the user with the new relevant information retrieved from the data sources.

17. The computer program product of claim 14 further comprising:
receiving, by the computer, the image from an image capturing device corresponding to the user via a network; and
generating, by the computer, image contextual relevancy classification data corresponding to the image by performing image analysis of the image to identify objects in the image, searching the knowledge corpus to identify previous message text referencing the objects identified in the image and related objects to the objects identified in the image, and performing textual analysis of message text sent with the image.

18. The computer program product of claim 17 further comprising:
generating, by the computer, a set of insights corresponding to the user based on the image contextual relevancy classification data corresponding to the image; and
generating, by the computer, a confidence score for each respective insight of the set of insights corresponding to the user.

19. The computer program product of claim 18 further comprising:
comparing, by the computer, the confidence score of each respective insight of the set of insights corresponding to the user to a minimum confidence score threshold value; and
determining, by the computer, whether one or more confidence scores are greater than the minimum confidence score threshold value.

20. The computer program product of claim 19 further comprising:
responsive to the computer determining that one or more confidence scores are greater than the minimum confidence score threshold value, generating, by the computer, the notification containing those insights having confidence scores greater than the minimum confidence score threshold value; and
sending, by the computer, the notification containing those insights having confidence scores greater than the minimum confidence score threshold value to the set of interested parties in a list of permissible contacts for notification via the network.
